(19) United States
(12) Patent Application Publication
(10) Pub. No.: US 2018/0253637 A1
(43) Pub. Date: Sep. 6, 2018

(54) CHURN PREDICTION USING STATIC AND DYNAMIC FEATURES

(71) Applicant: Microsoft Technology Licensing, LLC, Redmond, WA (US)

(72) Inventors: Feng Zhu, Bothell, WA (US); Xinying Song, Bellevue, WA (US); Chao Zhong, REDMOND, WA (US); Shijing Fang, Redmond, WA (US); Ryan Bouchard, Redmond, WA (US); Valentine N. Fontama, Bellevue, WA (US); Prabhdeep Singh, Newcastle, WA (US); Jianfeng Gao, Woodinville, WA (US); Li Deng, Redmond, WA (US)

(73) Assignee: Microsoft Technology Licensing, LLC

(21) Appl. No.: 15/446,870

(22) Filed: Mar. 1, 2017

(51) Int. Cl. G06N 3/04; G06N 5/04; H04L 29/08

(52) U.S. Cl. CPC G06N 3/04; H04L 67/10; G06N 5/04

(57) ABSTRACT

A method to predict churn includes obtaining static features representative of a customer of a service, obtaining time series features representative of the customers interaction with the service, using a deep neural network to process the static features, using a recurrent neural network to process the time series features; and combining outputs from the deep neural network and the recurrent neural network to predict likelihood of customer churn.

### BACKGROUND

Predictive models have been used to identify customers who are at a high risk of churning. Such predictive models have involved the use a machine learning model, such as a random forest classification model using hundreds of features culled from customer use of the service. Both static and dynamic variables using commercial/billing data. Weekly reports were generated to alert product managers and account managers regarding risk of churning, allowing the managers to take actions to attempt to retain customers.

As the number of time series data increases or explodes, the number of features for use by the models will grow exponentially. At least one model utilized a recurrent neural network to model one or multiple time series of customer actions in order to predict customer churn. There is a desire to further improve model performance to predict customer churn.

### SUMMARY

A method to predict churn includes obtaining static features representative of a customer of a service, obtaining time series features representative of the customer's interaction with the service, using a deep neural network to process the static features, using a recurrent neural network to process the time series features; and combining outputs from the deep neural network and the recurrent neural network to predict likelihood of customer churn.

A machine readable storage device has instructions for execution by a processor of the machine to perform operations. The operations include obtaining static features representative of a customer of a service, obtaining time series features representative of the customer's interaction with the service, using a deep neural network to process the static features, using a recurrent neural network to process the time series features, and combining outputs from the deep neural network and the recurrent neural network to predict likelihood of customer churn.

A device includes a processor and a memory device coupled to the processor and having a program stored thereon for execution by the processor to perform operations. The operations include obtaining static features representative of a customer of a service, obtaining time series features representative of the customer's interaction with the service, using a deep neural network to process the static features, using a recurrent neural network to process the time series features, and combining outputs from the deep neural network and the recurrent neural network to predict a likelihood of customer churn.

### BRIEF DESCRIPTION OF THE DRAWINGS

FIG. 1 is a block diagram of a system and deep learning model architecture that includes a deep neural network and recurrent neural network to predict churn according to an example embodiment.

FIG. 2 is a block flow diagram illustrating a deep neural network utilizing static features and a recurrent neural network utilizing dynamic features according to an example embodiment.

FIG. 3 is a block flow diagram illustrating multiple layers of a deep neural network according to an example embodiment.

FIG. 4 is a block diagram illustrating a recurrent neural network design according to an example embodiment.

FIG. 5 is a block flow diagram illustrating implementation of the recurrent neural network of FIG. 4 according to an example embodiment.

FIG. 6 is a block diagram illustrating an arrangement of FIGS. 6A, 6B, 6C, 6D, and 6E according to an example embodiment.

FIGS. 6A, 69, 6C, 6D, and 6E in combination are a block flow diagram illustrating implementation of a model including combined deep neural networks and deep recurrent neural networks for predicting customer churn according to an example embodiment.

FIG. 7A is a table illustrating a comparison of example model performance compared to prior models according to an example embodiment.

FIG. 7B is a graph illustrating a comparison of example model performance compared to prior models according to an example embodiment.

FIG. 8 is a flowchart illustrating a method performed by the combined model according to an example embodiment

FIG. 9 is a flowchart illustrating a method of combining outputs from the deep neural network and the recurrent neural network according to an example embodiment.

FIG. 10 is a block diagram of a computer system for performing methods and algorithms according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware based storage devices, either local or networked. Further, such functions correspond to modules, which may be software, hardware, firmware or any combination thereof. Multiple functions may be performed in one or more modules as desired, and the embodiments described are merely examples. The software may he executed on a digital signal processor, ASIC, microprocessor, or other type of processor operating on a computer system, such as a personal computer, server or other computer system, turning such computer system into a specifically programmed machine.

Churn prediction and prevention is a critical component of cloud service based businesses. Churn or churning may be associated with customer turnover, defection, loss, or other form of customer attrition. Since churn is a rare event, and churn patterns may vary significantly across customers, predicting churn is a challenging task when using conventional machine learning techniques. However, a massive and rich amount of customer usage and billing data enables the exploitation of advanced machine learning techniques to create models to discover complex usage patterns for churn. Features extracted from time series data may grow exponentially and result in significant consumption of computing resources for prior customer relationship management machine learning systems.

A system and method utilize a deep neural network (DNN) and a recurrent neural network (RNN) to process static and time series data related to customer churn with respect to services. Both networks may include multiple layers to transform raw inputs into churn prediction outputs. The outputs of both neural networks are combined to provide a likelihood that a customer will elect to no longer participate in services. The stacking of the multiple layers of neural networks is referred to as architecture engineering. The combination of a deep neural network with a recurrent neural network provides increased accuracy as compared to prior use of separate random forest classification.

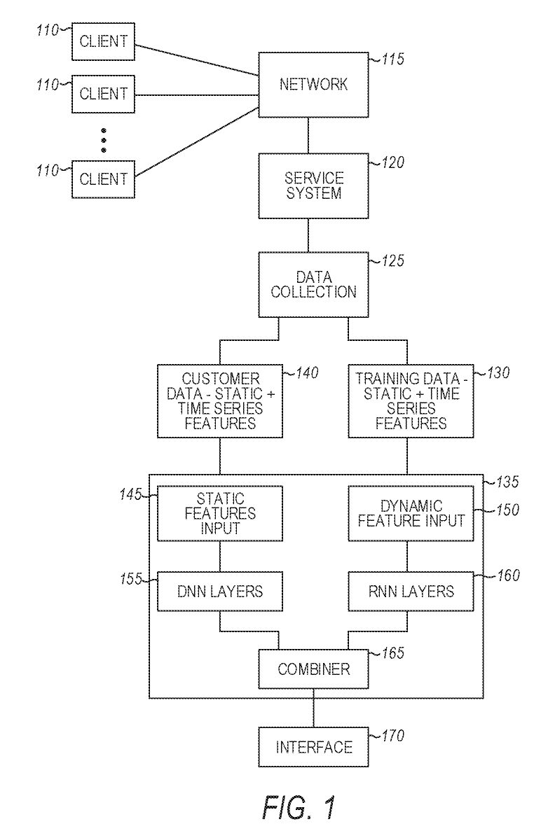

FIG. 1 is a block diagram of a system 100 that utilizes a neural network model to predict customer churn. In one embodiment, multiple customers, shown as clients 110 are coupled to a network 115 to obtain services from a service system 120. The service system 120 may be for example, a subscription to an on-line service for information, cloud services, such as cloud based data storage, or other services that may be provided via network 115. Data is collected at 125 from the service system 120. The data may include static features as well as time series features related to the utilization of services by the customers.

Static features may include data about customers stored in a data base, such as static data describing the customer and account information stored in customer fields. Example static features include offer type, tenure age, and billing status. In one embodiment, more than ten customer status variables may be used as static features. Time series data may include data collected regarding use of the service by the customers, such as usage telemetry logs documenting access and use of cloud based services, as well as various meters. Example time series data, also called dynamic features include daily usage of cloud services such as network, storage, virtual machine, etc. In some embodiments, over 400 variables may be extracted from the time series data. The data in one embodiment is collected over an eight week usage period. The training data in one example included over 98,000 samples.

Data collection 125 occurs during a training stage to provide training data 130 that includes both static and time series features. Data 130 may also include whether or not the customer actually did churn. Data 130 will be used to train a hybrid deep learning network model 135 to predict customer churn.

Data collection 125 also occurs during use of the system service 120 to provide customer data 140 for determining the likelihood that a customer will churn by the network model 135 once trained. Customer data 140 includes static and time series features collected during actual use of the service system 120 and is processed by the network model 135 to determine likelihood of churn for individual customers.

Network model 135 divides the feature inputs into a static feature input 145 and a dynamic feature input 150. The static feature input 145 provides static features to multiple layers of deep neural networks 155. The dynamic feature input 150 provides the time series features to one or more recurrent neural network layers 160. Outputs of the deep neural networks 155 and recurrent neural network layers 160 are combined at a combiner 165 to provide an indication of the likelihood of customer churn for each customer.

The network model 135 may initially be trained by observing the features and correlating them to actual churn. Following training, the network model 135 may be run periodically against one or more customers to obtain the indication or prediction of whether or not the customer is likely to churn. In one embodiment, the indication may simply be binary, such as a “1” or a “0”, with “1” meaning that the customer is a churn candidate. The prediction may also be expressed as a value between 0 and 1 in further embodiments, such as 0.75 for example, corresponding to 75% likely to churn.

An interface 170 may be used to provide the results generated by model 135. Results may be provided in periodic reports, such as weekly or monthly. Results may also be displayed in a dashboard, allowing timely contacting of customers likely to churn.

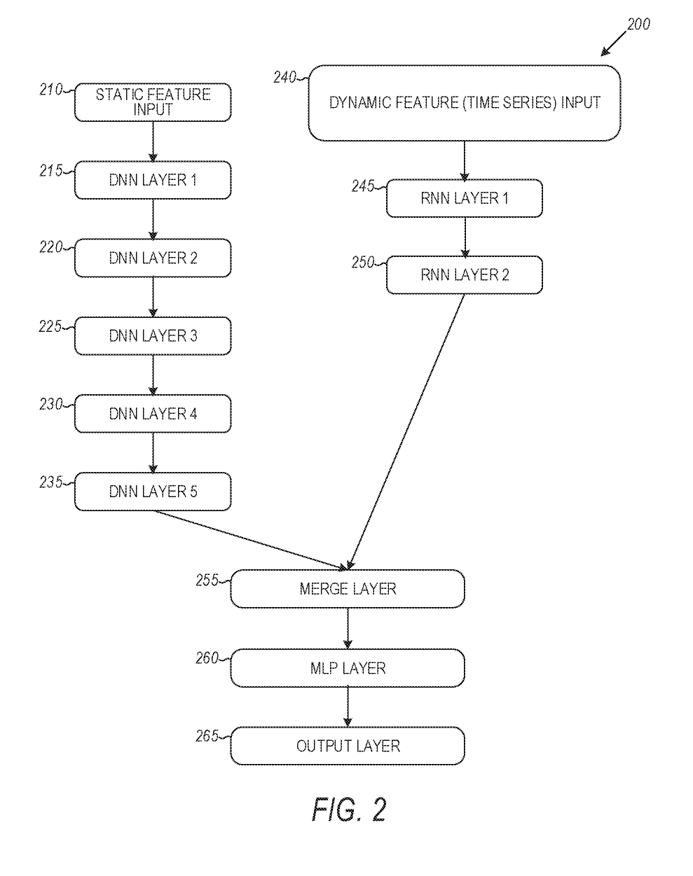

FIG. 2 is a block diagram showing a more detailed view of a neural network model at 200. Static feature input 210 is shown feeding features to first deep neural network (DNN) layer 215. In one embodiment, the first DNN layer 215 has 455 input dimensions and 32 output dimensions. Further DNN layers two through five are indicated at 220, 225, 230, and 235. DNN layers two through five have 32 input dimensions and 32 output dimensions in one embodiment. The DNN layers may be identical in one embodiment and each DNN layer may include batch normalization and have a highway-like architecture.

Network model 200 also has a dynamic feature input 240 that provides time series features to a first recurrent neural network (RNN) layer at 245, which is coupled to a second RNN layer at 250. The RNN layers may be identical and run long short-term memory (LSTM). First RNN layer 245 in one embodiment has a 56×18 input dimension and a 56×18 output dimension. The second RNN layer 250 may have a 56×18 input dimension and a 128 output dimension. Each RNN layer may also have a highway-like architecture in one embodiment.

The results from the DNN layers and RNN layers are combined at a merge layer 255. With the highway-like architecture, results from each of the layers are included to be combined. The merged results are then processed via a multi-layer perceptron (MLP) layer 260 to approximate a risk score that is provided by output layer 265.

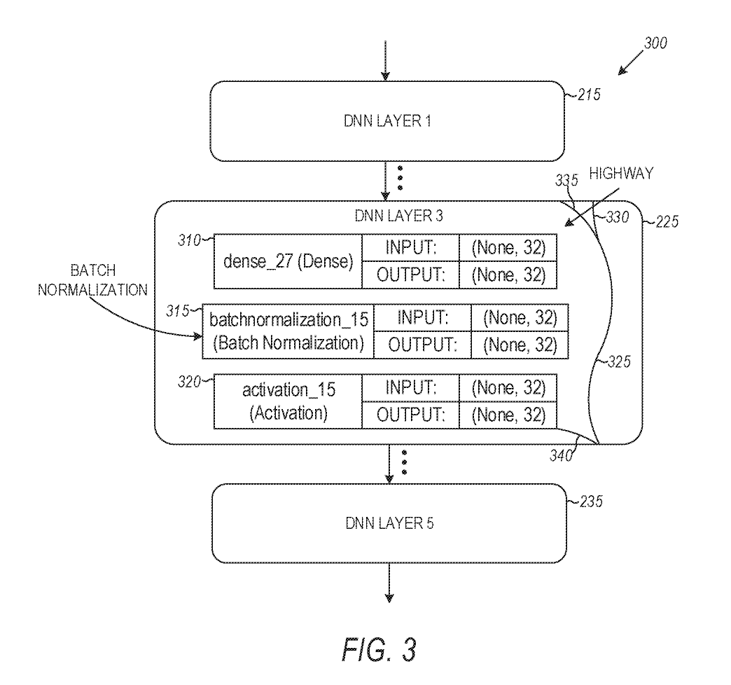

FIG. 3 is a block flow diagram illustration of DNN layers indicated generally at 300. DNN layer 1 is illustrated at 215 and DNN layer 3 is shown with further detail at 225. DNN layer 3 at 225 includes dense layer 310 that is a fully connected layer that receives all the output from a previous layer as its input and generates outputs based on the inputs. The output is provided to a batch normalization layer 315 that normalizes outputs for each feature to preserve the representation of the layer. An activation function 320 is applied to the normalized representation to produce a non-linear decision boundary via non-linear transformation of inputs.

A highway 325 is provided to obtain results from each DNN layer. The highway 325 in one embodiment collects the results from each DNN layer and provides the results to the merge layer 255. In FIG. 3, the highway includes a branch 335 to receive results from a previous layer, as well as a branch 330 that propagates results from other previous layers. Results from DNN layer 3 are provided to the highway 325 via branch 340. For simplicity of illustration, the highway 325 is only shown in a larger view of DNN layer 3.

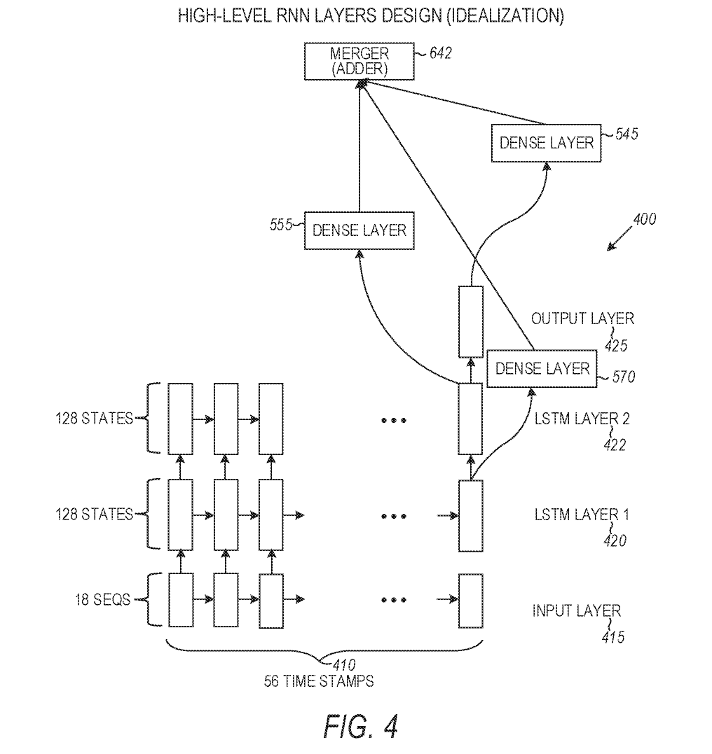

FIG. 4 is a block diagram of a high level RNN layer design 400. In one embodiment time stamps 410 corresponding to the time series data are received by an RNN layer. In one embodiment, 56 such time stamps are received at an input layer 415. An input dimension of 56×18 sequences is received at the input layer 415. Each single RNN layer, such as hidden layer 1 at 420 and layer 2 at 422, outputs 128 state output at each timestamp, yielding in total 56×128 output. That is to say, the output of RNN is also a sequence, which can in turn be fed into another RNN as the input of the latter RNN. Only on the final RNN layer, output layer 425 one may take the 128 state output at the final timestamp, feed into a dense layer to reach a prediction for the original input time series sequence. The hidden layers basically the trained layer that applies learned rules to the input data to reach a prediction. Note that the dimensions may be different in other embodiments and may be a design parameter related to the situation being modeled.

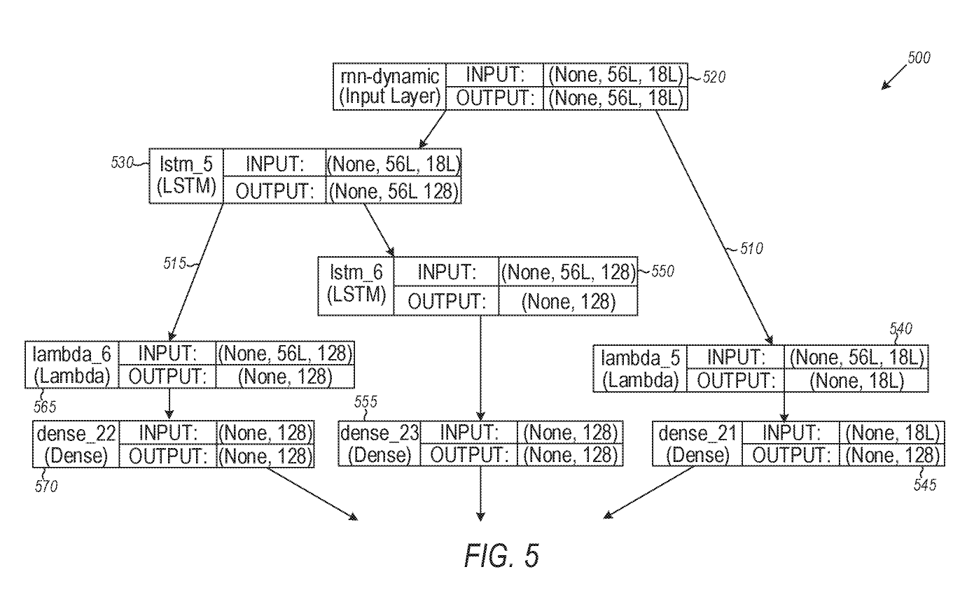

When highway connections are applied to RNN, the final 128 state output for each RNN layer is fed into the highway links, and propagates to the final output. The “action” of taking the final 128 state output from RNN's entire 56×128 output is illustrated as “lambda” block (540, 565) in FIG. 5.

FIG. 5 is a block flow diagram illustrating details 500 of implementation of the RNN layers 245 and 250, including illustration of the highway 510, 515 connecting the RNN layers. An RNN dynamic input layer 520 receives the time series data and is followed by LSTM 530. Input layer 520 also provides data to a data, highway 510. Highway 510 includes a lambda layer 540 and dense layer 545. Lambda layer 540 receives 56*128 time series inputs and simply takes the last 128 output at the final timestamp to generate a 128 output.

LSTM 530 provides it output as an input to LSTM 550 to provide output to dense layer 555. LSTM 530 also provides output to highway 515 which includes a lambda layer 565 and dense layer 570. The dense layers 545, 555, and 570 provide results to merge layer 255. The dense layers 545, 555, and 570 are also indicated in FIG. 4. Input and output sizes for the various layers are illustrated in FIG. 5 as previously described.

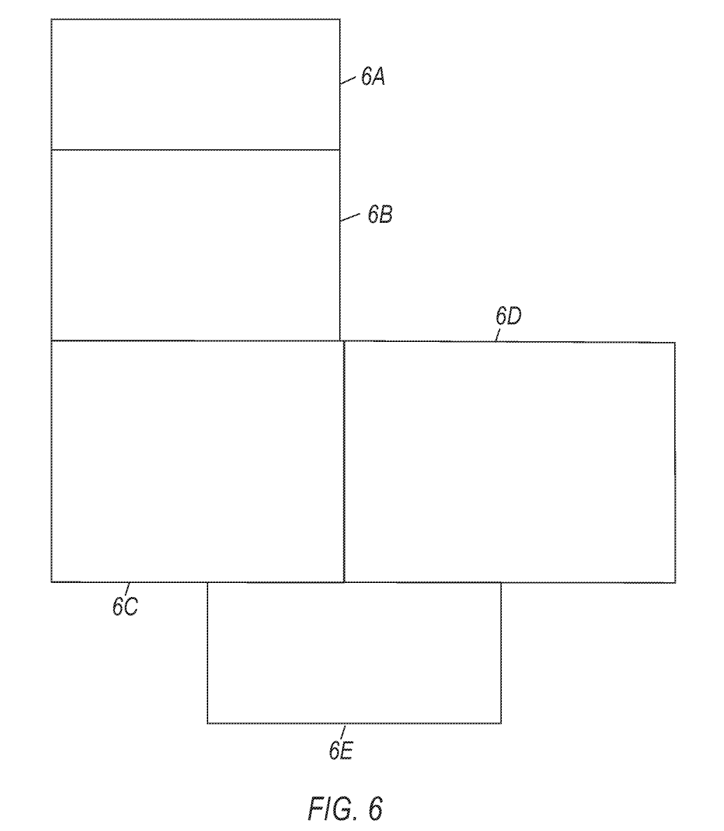

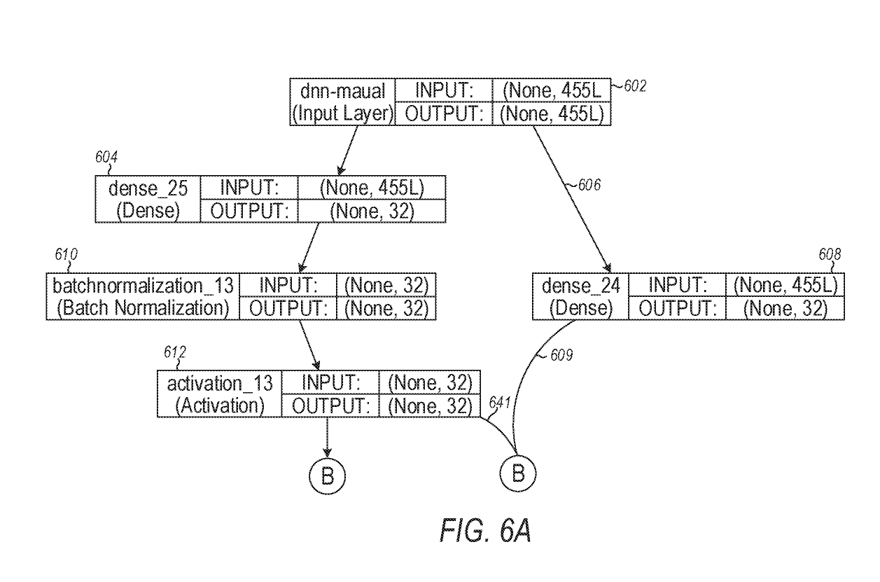

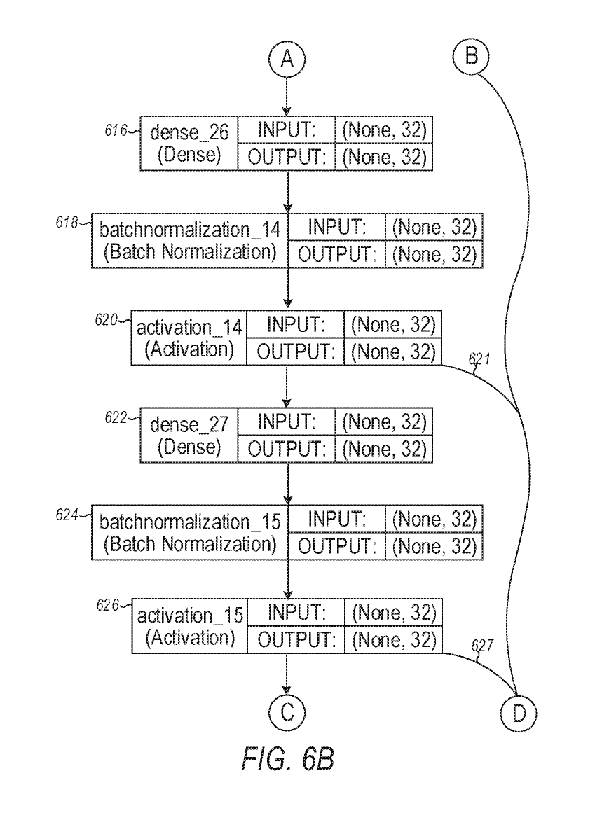

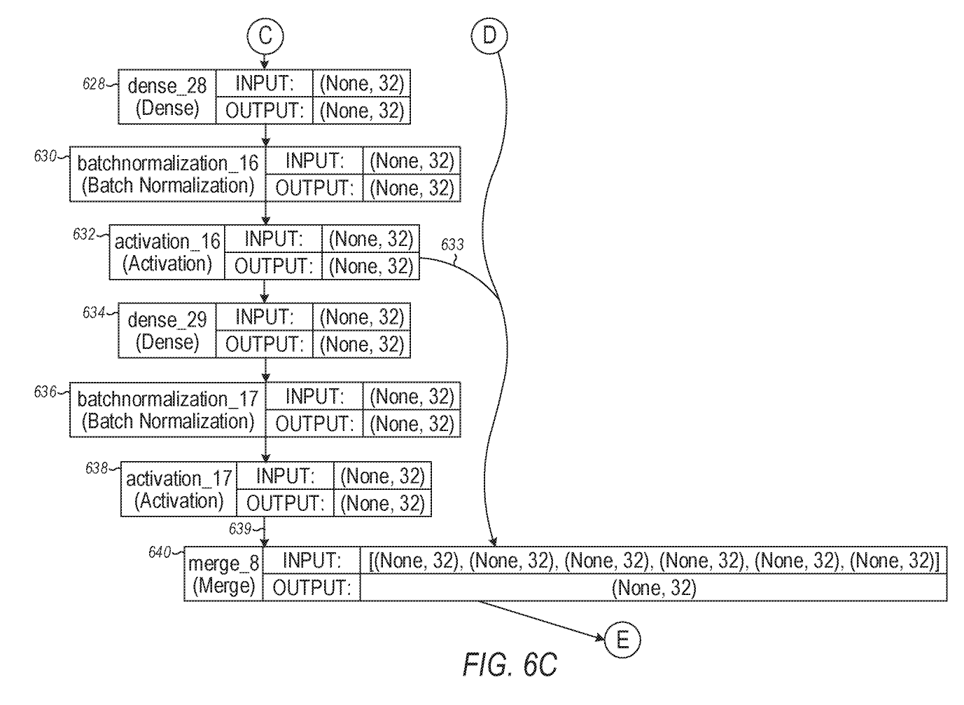

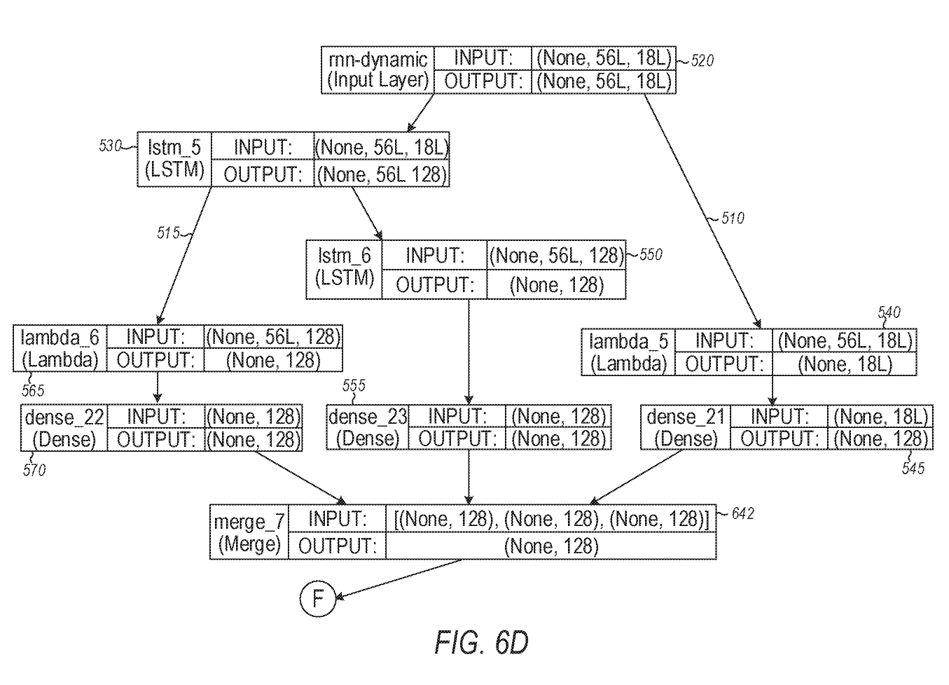

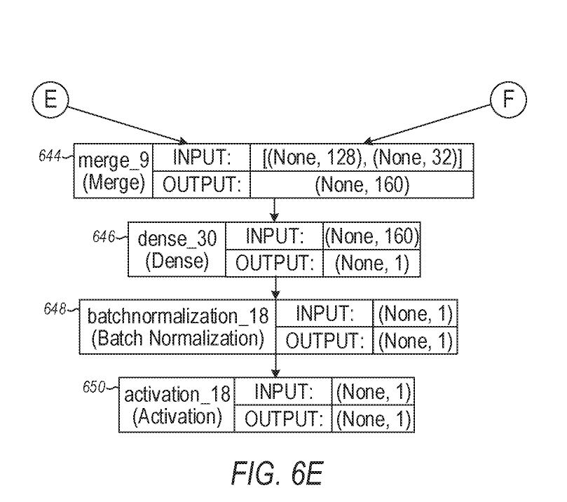

FIG, 6 is a block diagram illustrating arrangements of FIGS. 6A, 6B, 6C, 6D, and 6E which illustrate a block flow diagram of implementation of a the network model at 600. FIG. 6A illustrates a DNN manual input layer at 602 that provides data to the first DNN layer at a dense layer 604 and via a connection 606 dense layer 608, which processes the input data and provides it on highway 609. The first DNN layer, in addition to dense layer 604 includes a batch normalization layer 610 and activation layer 612. Activation layer 614 is coupled to highway 609 via connection 614.

FIG. 6B includes the second and third DNN layers, which may be of an identical architecture to the first DNN layer. The second DNN layer includes dense layer 616, batch normalization layer 618 and activation layer 620 that is coupled to highway 609 via connection 621. The third DNN layer includes dense layer 622, batch normalization layer 624 and activation layer 626 that is coupled to highway 609 via connection 627.

FIG. 6C includes the fourth and fifth DNN layers, which may be of an identical architecture to the other DNN layers. The fourth DNN layer includes dense layer 628, batch normalization layer 630 and activation layer 632 that is coupled to highway 609 via connection 633. The fifth DNN layer includes dense layer 634, batch normalization layer 636 and activation layer 638 that is coupled to highway 609 via connection 639. A merge layer 640 receives output from activation layer 638 as well as highway 609 from DNN layers one through four and input 602.

FIG. 6D includes the RNN layers and are numbered consistently with the RNN layers in FIG. 5. The RNN layers provide output from dense layers 545, 555, and 565 to a merge layer 642.

FIG. 6E illustrates the combining layer and includes a merge layer 644 that merges output from merge layers 640 and 642. The merged output is provided to a dense layer 646, followed by a batch normalization layer 648, and an activation layer 650. In one embodiment, merging may be accomplished by simply concatenating the outputs. The input and output sizes of each layer in FIG. 6 is indicated in the layer itself.

A comparison of model performance based on a set of 98,247 training samples with 21,054 valid samples, and 21,053 test samples was taken over 8 weeks. Time-series variables included 18 daily usage data points. Static variables include more than 10 customer status variables and 400+ dynamic variables extracted from the time series data. Customers that churned were labeled with a binary value, such as 0 for no churn or 1 for a customer that churned.

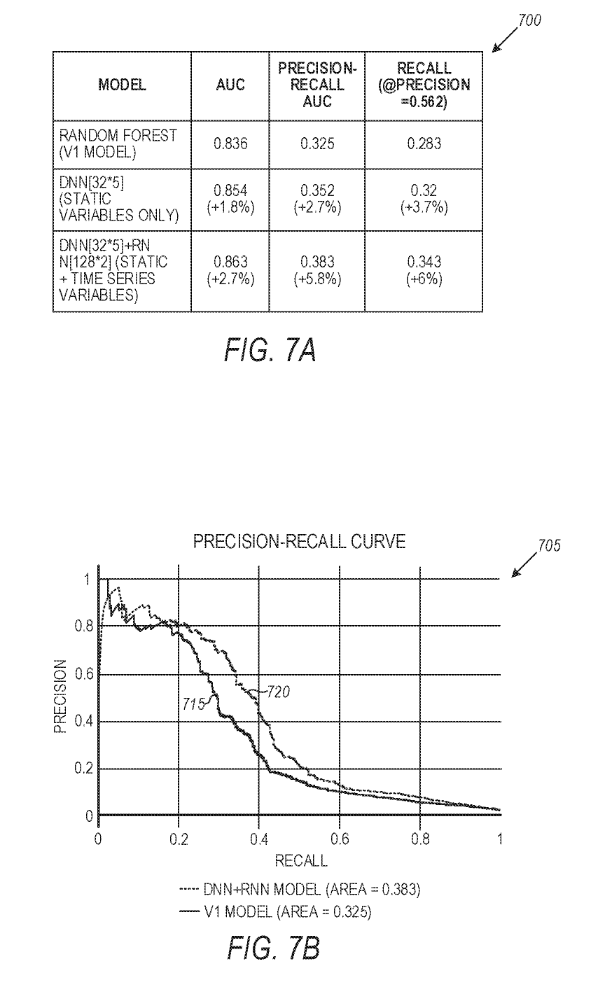

When compared with a random forest model and a DNN operating on static variables only, significant increases were noted across all performance metrics for the combined model. A precision-recall curve is illustrated in FIGS. 7A and 7B at 700 and 705 with a random forest model performance indicated at line 715 and the combined DNN+RNN model indicated at line 720. The y-axis is labeled precision, and the x-axis is labeled recall. The combined model performance 700 is above the random forest 710 at almost all points.

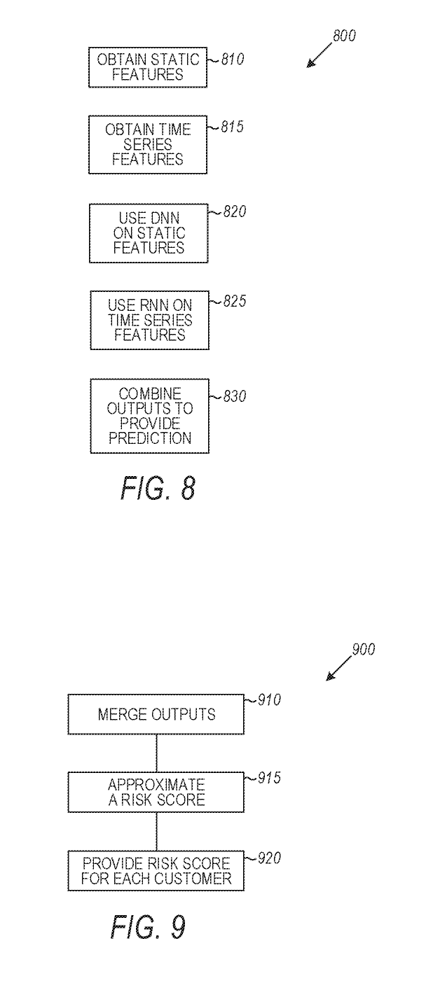

FIG. 8 is a flowchart illustrating a method 800 performed by the combined model. At 810, static features representative of a customer of a service are obtained. The features may be obtained from information contained in a database used by the service provider to track and bill customers, and may include customer preferences, billing information, cumulative usage information and other information that may be relevant to whether or not a customer is likely to churn. At 815, time series features representative of the customer's interaction with the service is obtained. The time series features may be derived from information gathered by tools that measure the utilization of the service by customers, such as data storage usage over time.

At 820, a deep neural network having multiple neural network layers coupled in series is used to process the static features. At 825, a recurrent neural network having two or more layers is used to process the time series features. Outputs from the deep neural network and the recurrent neural network are combined at 830 to predict customer churn.

In one embodiment, the deep neural network comprises multiple deep neural network layers wherein a first deep neural network layer receives the static features as inputs and each succeeding deep neural network layer processes an output of a previous layer. Each deep neural network layer may have the same output dimension. A last layer provides a last layer output to a merge function and the other layer outputs are provided via a highway-like architecture to the merge function to provide the deep neural network output for combining with the recurrent neural network output. In one embodiment, each layer at each deep neural network layer may perform batch normalization.

In one embodiment, the recurrent neural network comprises a first recurrent neural network layer and a second recurrent neural network layer. The first neural network layer receives the time series features and provides a first output as an input to the second recurrent neural network layer. The second recurrent neural network layer provides the recurrent neural network output.

FIG. 9 is a flowchart illustrating a method 900 of combining outputs from the deep neural network and the recurrent neural network. Method 900 may include merging the outputs at 910, using a multi-layer perceptron (MLP) to approximate a risk score at 915, and providing the risk score corresponding to a likelihood of churn for each customer at 920.

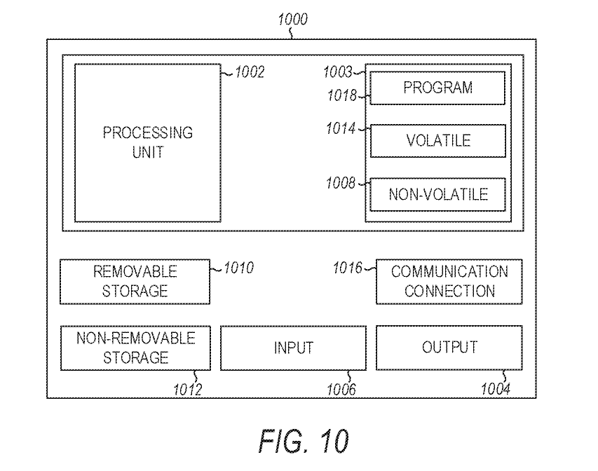

FIG. 10 is a block schematic diagram of a computer system 1000 to implement customer churn prediction methods and algorithms according to example embodiments. All components need not be used in various embodiments. One example computing device in the form of a computer 1000, may include a processing unit 1002, memory 1003, removable storage 1010, and non-removable storage 1012. Although the example computing device is illustrated and described as computer 1000, the computing device may be in different forms in different embodiments. For example, the computing device may instead be a smartphone, a tablet, smartwatch, or other computing device including the same or similar elements as illustrated and described with regard to FIG. 10. Devices such as smartphones, tablets, and smartwatches are generally collectively referred to as mobile devices. Further, although the various data storage elements are illustrated as part of the computer 1000, the storage may also or alternatively include cloud-based storage accessible via a network, such as the Internet.

Memory 1003 may include volatile memory 1014 and non-volatile memory 1008. Computer 1000 may include—or have access to a computing environment that includes a variety of computer-readable media, such as volatile memory 1014 and non-volatile memory 1008, removable storage 1010 and non-removable storage 1012. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices capable of storing computer-readable instructions for execution to perform functions described herein.

Computer 1000 may include or have access to a computing environment that includes input 1006, output 1004, and a communication connection 1016. Output 1004 may include a display device, such as a touchscreen, that also may serve as an input device. The input 1006 may include one or more of a touchscreen, touchpad, mouse, keyboard, camera, one or more device-specific buttons, one or more sensors integrated within or coupled via wired or wireless data connections to the computer 1000, and other input devices. The computer may operate in a networked environment using a communication connection to connect to one or more remote computers, such as database servers, including cloud based servers and storage. The remote computer may include a personal computer (PC), server, router, network PC, a peer device or other common network node, or the like. The communication connection may include a Local Area Network (LAN), a Wide Area Network (WAN), cellular, Wi-Fi, Bluetooth, or other networks.

Computer-readable instructions stored on a computer-readable storage device are executable by the processing unit 1002 of the computer 1000. A hard drive, CD-ROM, and RAM are some examples of articles including a non-transitory computer-readable medium such as a storage device. For example, a computer program 1018 may be used to cause processing unit 1002 to perform one or more methods or algorithms described herein.

Additional examples of the presently described method, system, and device embodiments include the following, non-limiting configurations. Each of the following non-limiting examples may stand on its own, or may be combined in any permutation or combination with any one or more of the other examples provided below or throughout the present disclosure.

### Example 1

A method to predict churn, the method comprising: obtaining static features representative of a customer of a service; obtaining time series features representative of the customer's interaction with the service; using a deep neural network to process the static features; using a recurrent neural network to process the time series features; and combining outputs from the deep neural network and the recurrent neural network to predict likelihood of customer churn.

### Example 2

The method of example 1 wherein the deep neural network comprises multiple deep neural network layers wherein a first deep neural network layer receives the static features as inputs and each succeeding deep neural network layer processes an output of a previous layer.

### Example 3

The method of example 2 wherein each deep neural network layer has a same output dimension.

### Example 4

The method of any of examples 2-3 wherein a last layer provides a last layer output to a merge function, and wherein the other layer outputs are provided via a highway-like architecture to the merge function to provide the deep neural network output for combining with the recurrent neural network output.

### Example 5

The method of any of examples 2-4 and further comprising performing batch normalization at each deep neural network layer.

### Example 6

The method of any of examples 1-5 wherein the recurrent neural network comprises a first recurrent neural network layer and a second recurrent neural network layer.

### Example 7

The method of example 6 wherein the first neural network layer receives the time series features and provides a first output as an input to the second recurrent neural network layer.

### Example 8

The method of example 7 wherein the second recurrent neural network layer provides the recurrent neural network output.

### Example 9

The method of any of examples 1-8 wherein combining outputs from the deep neural network and the recurrent neural network comprises: merging the outputs; using a multi-layer perceptron (MLP) to approximate a risk score; providing the risk score corresponding to a likelihood of churn for the customer.

### Example 10

The method of any of examples 1-9 wherein the static features include at least one of static features include offer type, tenure age, and billing status.

### Example 11

The method of example 10 wherein the dynamic features include at least one of daily usage of cloud services including network, storage, and virtual machine.

### Example 12

A machine readable storage device having instructions for execution by a processor of the machine to perform operations comprising: obtaining static features representative of a customer of a service; obtaining time series features representative of the customer's interaction with the service; using a deep neural network to process the static features; using a recurrent neural network to process the time series features; and combining outputs from the deep neural network and the recurrent neural network to predict likelihood of customer churn.

### Example 13

The storage device of example 12 wherein the deep neural network comprises multiple deep neural network layers wherein a first deep neural network layer receives the static features as inputs and each succeeding deep neural network layer processes an output of a previous layer and wherein each deep neural network layer has a same output dimension.

### Example 14

The storage device of any of examples 12-13 wherein a last layer provides a last layer output to a merge function, and wherein the other layer outputs are provided via a highway-like architecture to the merge function to provide the deep neural network output for combining with the recurrent neural network output.

### Example 15

The storage device of any of examples 12-14 wherein the recurrent neural network comprises a first recurrent neural network layer and a second recurrent neural network layer, wherein the first neural network layer receives the time series features and provides a first output as an input to the second recurrent neural network layer, and wherein the second recurrent neural network layer provides the recurrent neural network output.

### Example 16

The storage device of any of examples 12-15 wherein combining outputs from the deep neural network and the recurrent neural network comprises: merging the outputs; using a multi-layer perceptron (MLP) to approximate a risk score; providing the risk score corresponding to a likelihood of churn for the customer.

### Example 17

The storage device of any of examples 12-16 wherein the static features include at least one of static features include offer type, tenure age, and billing status and wherein the dynamic features include at least one of daily usage of cloud services including network, storage, and virtual machine.

### Example 18

A device comprising: a processor; and a memory device coupled to the processor and having a program stored thereon for execution by the processor to perform operations comprising: obtaining static features representative of a customer of a service; obtaining time series features representative of the customer's interaction with the service; using a deep neural network to process the static features; using a recurrent neural network to process the time series features; and combining outputs from the deep neural network and the recurrent neural network to predict a likelihood of customer churn.

### Example 19

The device of example 18 wherein the deep neural network comprises multiple deep neural network layers wherein a first deep neural network layer receives the static features as inputs and each succeeding deep neural network layer processes an output of a previous layer and wherein each deep neural network layer has a same output dimension, wherein the recurrent neural network comprises a first recurrent neural network layer and a second recurrent neural network layer, wherein the first neural network layer receives the time series features and provides a first output as an input to the second recurrent neural network layer, and wherein the second recurrent neural network layer provides the recurrent neural network output, and wherein combining outputs from the deep neural network and the recurrent neural network comprises: merging the outputs; using a multi-layer perceptron (MLP) to approximate a risk score; providing the risk score corresponding to a likelihood of churn for the customer.

### Example 20

The device of any of examples 18-19 wherein the static features include at least one of static features include offer type, tenure age, and billing status and wherein the dynamic features include at least one of daily usage of cloud services including network, storage, and virtual machine.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method to predict churn, the method comprising:
obtaining static features representative of a customer of a service;
obtaining time series features representative of the customer's interaction with the service;
using a deep neural network to process the static features;
using a recurrent neural network to process the time series features; and
combining outputs from the deep neural network and the recurrent neural network to predict likelihood of customer churn.

2. The method of claim 1 wherein the deep neural network comprises multiple deep neural network layers wherein a first deep neural network layer receives the static features as inputs and each succeeding deep neural network layer processes an output of a previous layer.

3. The method of claim 2 wherein each deep neural network layer has a same output dimension.

4. The method of claim 2 wherein a last layer provides a last layer output to a merge function, and wherein the other layer outputs are provided via a highway-like architecture to the merge function to provide the deep neural network output for combining with the recurrent neural network output.

5. The method of claim 2 and further comprising performing batch normalization at each deep neural network layer.

6. The method of claim 1 wherein the recurrent neural network comprises a first recurrent neural network layer and a second recurrent neural network layer.

7. The method of claim 6 wherein the first neural network layer receives the time series features and provides a first output as an input to the second recurrent neural network layer.

8. The method of claim 7 wherein the second recurrent neural network layer provides the recurrent neural network output.

9. The method of claim 1 wherein combining outputs from the deep neural network and the recurrent neural network comprises:
merging the outputs;
using a multi-layer perceptron (MLP) to approximate a risk score; and
providing the risk. score corresponding to a likelihood of churn for the customer.

10. The method of claim 1 wherein the static features include at least one of static features include offer type, tenure age, and billing status.

11. The method of claim 10 wherein the dynamic features include at least one of daily usage of cloud services including network, storage, and virtual machine.

12. A machine readable storage device having instructions for execution by a processor of the machine to perform operations comprising:
obtaining static features representative of a customer of a service;
obtaining time series features representative of the customer's interaction with the service;
using a deep neural network to process the static features;
using a recurrent neural network to process the time series features; and
combining outputs from the deep neural network and the recurrent neural network to predict likelihood of customer churn.

13. The storage device of claim 12 wherein the deep neural network comprises multiple deep neural network layers wherein a first deep neural network layer receives the static features as inputs and each succeeding deep neural network layer processes an output of a previous layer and wherein each deep neural network layer has a same output dimension.

14. The storage device of claim 12 wherein a last layer provides a last layer output to a merge function, and wherein the other layer outputs are provided via a highway-like architecture to the merge function to provide the deep neural network output for combining with the recurrent neural network output.

15. The storage device of claim 12 wherein the recurrent neural network comprises a first recurrent neural network layer and a second recurrent neural network layer, wherein the first neural network layer receives the time series features and provides a first output as an input to the second recurrent neural network layer, and wherein the second recurrent neural network layer provides the recurrent neural network output.

16. The storage device of claim 12 wherein combining outputs from the deep neural network and the recurrent neural network comprises:
merging the outputs;
using a multi-layer perceptron (MLP) to approximate a risk score; and
providing the risk score corresponding to a likelihood of churn for the customer.

17. The storage device of claim 12 wherein the static features include at least one of static features include offer type, tenure age, and billing status and wherein the dynamic features include at least one of daily usage of cloud services including network, storage, and virtual machine.

18. A device comprising:
a processor; and
a memory device coupled to the processor and having a program stored thereon for execution by the processor to perform operations comprising:
obtaining static features representative of a customer of a service;
obtaining time series features representative of the customer's interaction with the service;
using a deep neural network to process the static features;
using a recurrent neural network to process the time series features; and
combining outputs from the deep neural network and neural network to predict a likelihood of customer churn.

19. The device of claim 18 wherein the deep neural network comprises multiple deep neural network layers wherein a first deep neural network layer receives the static features as inputs and each succeeding deep neural network layer processes an output of a previous layer and wherein each deep neural network layer has a same output dimension, wherein the recurrent neural network comprises a first recurrent neural network layer and a second recurrent neural network layer, wherein the first neural network layer receives the time series features and provides a first output as an input to the second recurrent neural network layer, and wherein the second recurrent neural network layer provides the recurrent neural network output, and wherein combining outputs from the deep neural network and the recurrent neural network comprises:
merging the outputs;
using a multi-layer perceptron (MLP) approximate a risk score; and
providing the risk score corresponding to a likelihood of churn for the customer.

20. The device of claim 18 wherein the static features include at least one of static features include offer type, tenure age, and billing status and wherein the dynamic features include at least one of daily usage of cloud services including network, storage, and virtual machine.
